(19) United States
(12) Patent Application Publication
(10) Pub. No.: US 2003/0111817 A1
(43) Pub. Date: Jun. 19, 2003

(54) Band for anti-lateral movement of stabilizer bar

(76) Inventors: Joseph Fader, Brighton, MI (US); Mamo Oshida, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/025,105

(22) Filed: Dec. 19, 2001

(51) Int. Cl. B60G 11/20

(52) U.S. Cl. 280/124.166; 280/124.137

(57) ABSTRACT

Bands fixedly attached to the outer surface of a stabilizer bar prevent lateral movement of the stabilizer bar during turning. As the stabilizer bar rotates in a pair of bushings during turning, the stabilizer bar tends to move laterally. One of the bands contacts the side of one of the bushings, preventing further lateral movement of the stabilizer bar. In one embodiment, the band includes an attachment portion on a first end and a notched portion on an opposing second end. The attachment portion expands after entry through the notched portion to secure the band to the stabilizer bar. Alternatively, the band includes an arm on a first end which engages a protrusion on a second end to secure the band to the stabilizer bar. In a third embodiment, a first inclined edge of a first portion of the band is slidingly engaged into a second inclined edge of a second portion of the band to secure the band to the stabilizer bar. A protrusion is deflected into a notch to secure the edges together. In a fourth embodiment, a bracket including apertures is positioned on the band such that flanges on opposing ends of the band are received in the apertures. The flanges are deflected to retain the bracket and secure the band to the stabilizer bar. In a fifth embodiment, the band includes a pair of opposing curved ends which are crushed after engagement to secure the band around the stabilizer bar.

### BACKGROUND OF THE INVENTION

The present invention relates generally to a band fixedly attached to a stabilizer bar which contacts a bushing as the stabilizer bar begins to move laterally as a result of external suspension force on the bar to prevent further lateral movement of the stabilizer bar.

Vehicles are commonly equipped with suspension systems for absorbing road shock and other vibrations, while providing for a smooth and comfortable ride. A suspension component, such as a stabilizer bar, is often used to increase roll rigidity and improve the steering stability of the vehicle. The stabilizer bar is generally attached to the lower A-arms of the suspension system and controls sway as the vehicle turns and provides an opposing push up and pull down force during cornering.

As a vehicle turns, the body of the vehicle rolls to the outside of the turn. The suspension components on the outside of the turn are generally compressed, while the suspension components on the inside of the turn are generally extended. The stabilizer bar counters this motion by pushing up on the suspension components collapsed and compressing the suspension components expanded through torsion in the stabilizer bar.

The stabilizer bar is typically connected to a vehicle frame by a pair of brackets. Rubber bushings are disposed within each the brackets between the stabilizer bar and the bracket to permit rotation of the stabilizer bar during turning maneuvers. The stabilizer bar tends to move laterally within the rubber bushings during rotation of the stabilizer bar.

Integral protrusions have been formed on the stabilizer bar to engage the bushings to prevent lateral movement of the stabilizer bar. As the stabilizer bar rotates during turning, the protrusions contacts the bushing, preventing lateral movement of the stabilizer bar. A drawback to utilizing these protrusions is that an additional forming step is required in forming the stabilizer bar, and the protrusion generates higher stresses in the bar which reduces the stabilizer bar's fatigue performance.

### SUMMARY OF THE INVENTION

A band tightly secured to the outer surface of a stabilizer bar prevents lateral movement of the stabilizer bar as the vehicle turns. The stabilizer bar is received in a pair of bushings which are each supported in a bracket that connects the stabilizer bar to the vehicle frame. A band is positioned adjacent to of each of the bushings. As the stabilizer bar rotates within the bushings as the vehicle turns, the stabilizer bar tends to move laterally. As the stabilizer bar begins to move laterally, one of the bands presses against the corresponding bushing, preventing further lateral movement of the stabilizer bar. In a preferred embodiment, the band is able to withstand approximately 300 pounds of force without slipping on the stabilizer bar.

In a first embodiment, the band includes a notched portion on a first end and a U-shaped attachment portion on an opposing second end. As the band wraps around the stabilizer bar, the ends move inwardly and the U-shaped attachment portion enters and passes through the notched portion. The opposing ends of the U-shaped attachment portion are each deflected, opening and flattening the attachment portion to retain the attachment portion the notched portion.

In a second embodiment, the band includes an arm which engages a protrusion in the band. The arm includes a hooked portion which engages a recessed portion on the protrusion. Alternatively, the arm includes a V-shaped recess which is engaged by a corresponding V-shaped projection on the protrusion. Preferably, the band further includes a pair of apertures which each receive a peg to further secure the band to the stabilizer bar.

In a third embodiment, the band includes a first and a second portion each including a deflectable tab, a notch, and an inclined edge. Each of the inclined edges include one of a recess and a corresponding projection which guide the sliding movement of the inclined edges during attachment of the band to the stabilizer bar. After sliding, the tabs are deflected into the respective notch, securing the band to the stabilizer bar.

In a fourth embodiment, the band includes a pair of flanges on opposing ends of the band. A bracket including a pair of corresponding apertures is positioned on the band such that the flanges are each inserted into one of the apertures. The flanges are deflected to tightly secure the band to the stabilizer bar.

In a fifth embodiment, the band includes a first curved portion having a first recess on a first end and a second curved portion having a second recess on an opposing second end. As the band wraps around the stabilizer bar, the ends move inwardly and each curved portion engages an opposing recess. The ends of the band are then crushed, securing the ends together.

Accordingly, the present invention provides a band which prevents lateral movement of the stabilizer bar during vehicle operation.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a perspective view of a vehicle suspension system;

FIG. 2 illustrates a top view of a vehicle suspension system employing a band secured to a stabilizer bar to prevent lateral movement;

FIG. 3a illustrates a perspective view of the first embodiment of the band prior to attachment to a stabilizer bar;

FIG. 3b illustrates a side view of the band of FIG. 3a during attachment to the stabilizer bar;

FIG. 3c illustrates a perspective view of the band of FIG. 3a in the secured position;

FIG. 4a illustrates a top view of a second embodiment of the band attached to a stabilizer bar;

FIG. 4b illustrates a cross sectional side view of a first type of attachment of the band of FIG. 4a taken along line 4b-4b;

FIG. 4c illustrates a cross sectional side view of a second type of attachment of the band of FIG. 4a taken along line 4b-4b;

FIG. 5a illustrates a top view of a third embodiment of the band prior to assembly on a stabilizer bar;

FIG. 5b illustrates a cross-sectional view of the inclined edges of the band of FIG. 5a taken along line Y-Y of FIG. 5d;

FIG. 5c illustrates the deflection of a tab into a notch of the band of FIG. 5a;

FIG. 5d illustrates the band of FIG. 5a attached to a stabilizer bar;

FIG. 6a illustrates a cross sectional view of a fourth embodiment of the band prior to securing to the stabilizer bar;

FIG. 6b illustrates a cross sectional partial view of the band of FIG. 6a attached to a stabilizer bar;

FIG. 7a illustrates a perspective view of the fifth embodiment of the band prior to attachment to a stabilizer bar;

FIG. 7b illustrates a side view of the band of FIG. 7a during attachment to the stabilizer bar; and

FIG. 7c illustrates a side view of the opposing ends of the band of FIG. 7a during crushing; and

FIG. 7d illustrates a perspective view of the band of FIG. 7a in the secured position.

### DETAILED DESCRIPTION OF THE PREFERRED EMBODIMENT

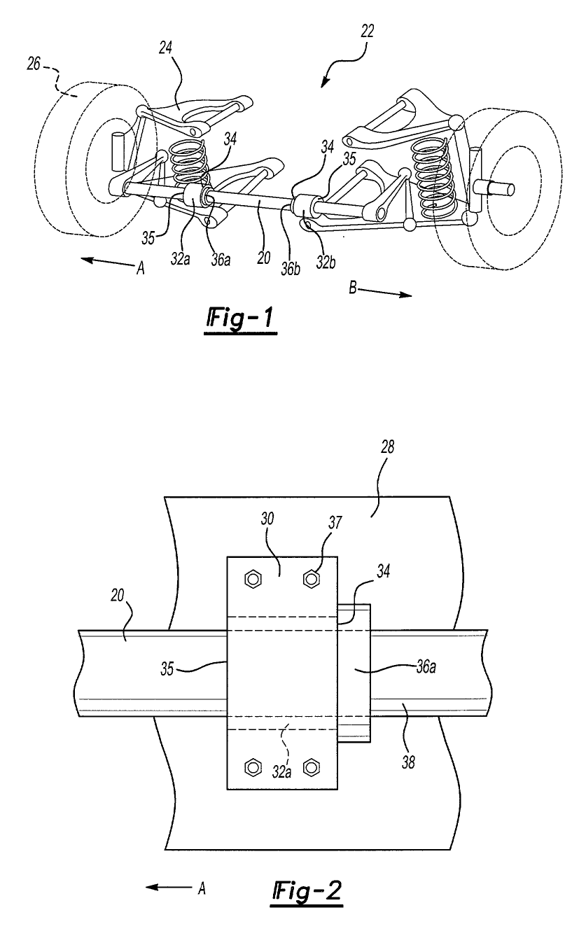

FIG. 1 illustrates a stabilizer bar 20 of a vehicle suspension system 22. As shown, the stabilizer bar 20, or anti-roll bar or anti-sway bar, is attached to control arms 24 which are connected to wheels 26. A pair of bushings 32a and 32b receive the stabilizer bar 20. As the stabilizer bar 20 deflects during turning, the stabilizer bar 20 rotates within the bushings 32a and 32b. Bands 36a and 36b are secured around the outer surface 38 of the stabilizer bar 20 adjacent to an inner side 34 of each of the bushings 32a and 32b, respectively. Although FIG. 1 illustrates both of the bands 36a and 36b positioned adjacent to the inner side 34 of the bushings 32a and 32b, respectively, it is to be understood that the bands 36a and 36b can also be positioned adjacent to the outer side 35 of each of the bushings 32a and 32b, respectively.

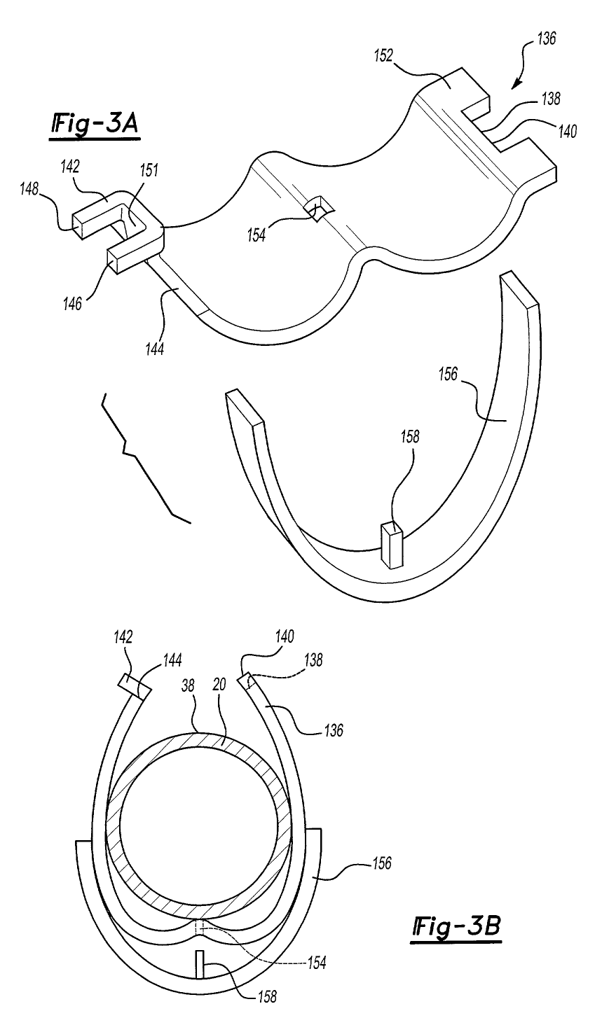

FIG. 2 illustrates the bushing 32a, shown in phantom, which is supported in a U-shaped bracket 30 which connects the stabilizer bar 20 to the vehicle frame 28. The bracket 30 is attached to the frame 28 by a plurality of attachment members 37. Returning to FIG. 1, as the stabilizer bar 20 rotates in the bushings 32a and 32b while the vehicle turns in a direction of turning, the stabilizer bar 20 tends to move laterally in direction A. The band 36a presses against the inner side 34 of the bushing 32a, preventing further lateral movement of the stabilizer bar 20. If the vehicle turns in an opposing direction of turning, the stabilizer bar 20 tends to move laterally in direction B, and the band 36b presses against the inner side 34 of the bushing 32b to prevent further lateral movement. The bands 36a and 36b are tightly secured to the stabilizer bar 20 and are preferably able to withstand at least approximately 300 pounds of force (about 1300 Newtons) from the bushings 32a and 32b without slipping on the stabilizer bar 20.

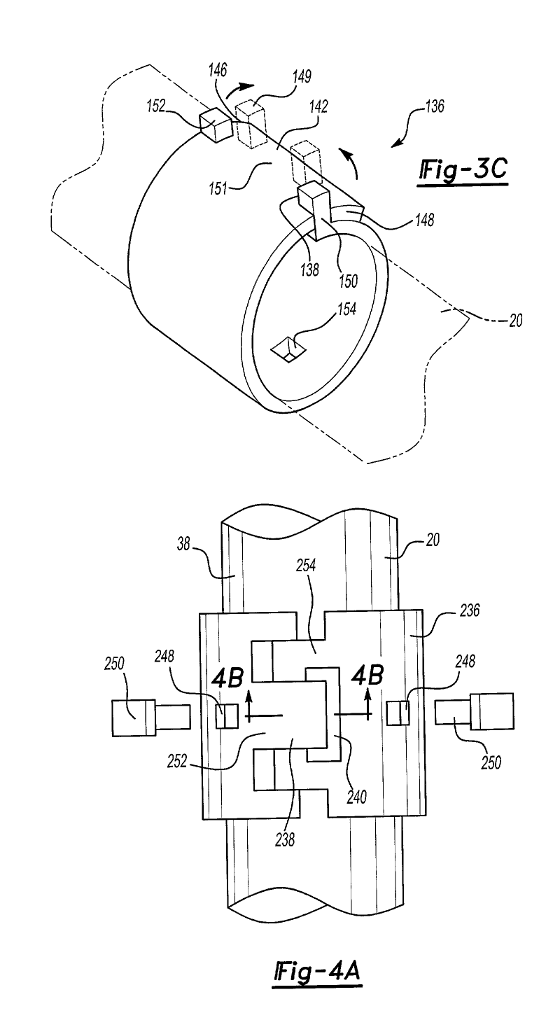

FIG. 3a illustrates a first embodiment of the band 136 of the present invention. The band 136 includes a notched portion 138 on a first end 140 and an attachment portion 142 connected to an opposing second end 144 by a connecting portion 151. Preferably, the attachment portion 142 is substantially U-shaped and includes parallel opposing projections 146 and 148. Prior to attachment of the band 136 to the stabilizer bar 20, the band 136 is positioned over a C-shaped trough 156. As the stabilizer bar 20 is pressed downwardly into the trough 156, as shown in FIG. 3b, the band 136 wraps around the outer surface 38 of the stabilizer bar 20, the ends 140 and 144 moving inwardly. As the stabilizer bar 20 is positioning in the trough 156, the connecting portion 151 of the attachment portion 142 enters the notched portion 138. As shown in FIG. 3c, the opposing projections 146 and 148 of the attachment portion 142 are then manually deflected 90° outwardly, opening and flattening the attachment portion 142. The original position of the projections 146 and 148 are shown in phantom at 149. The deflected projections 146 and 148 are retained by opposing protrusions 150 and 152 of the notched portion 138, tightly securing the band 136 around the outer surface 38 of the stabilizer bar 20. The stabilizer bar 20 is then removed from the trough 156 with the band 136 attached.

Preferably, the band 136 further includes a hole 154 positioned substantially in the center of the band 136 which aligns with a pin 158 in the trough 156 during attachment of the band 136 to the stabilizer bar 20. As the stabilizer bar 20 is pressed downwardly in the trough 156, the pin 158 engages the hole 154 to prevent sliding of the band 136 and to ensure the band 136 is positioned in the proper location on the stabilizer bar 20.

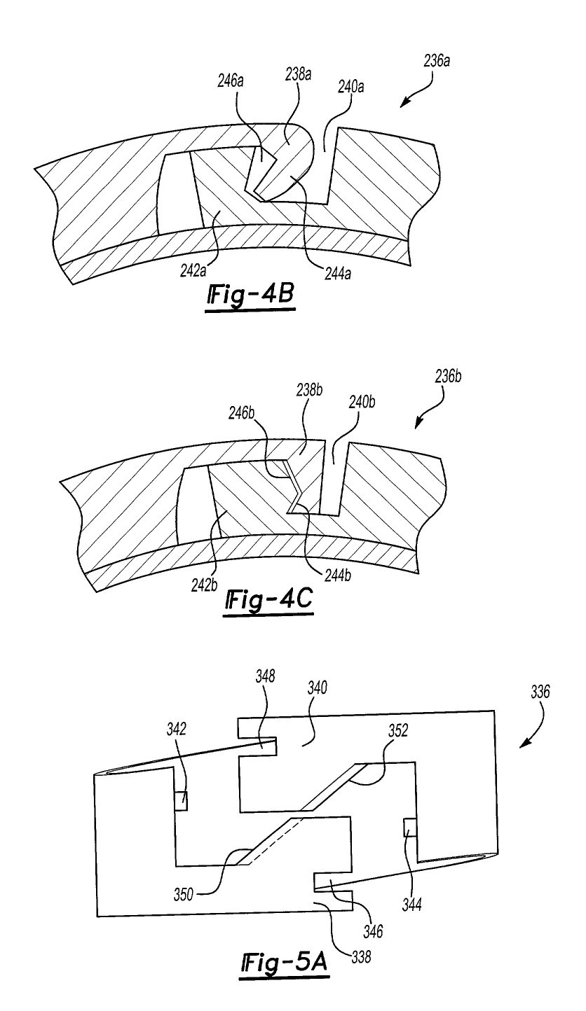

A second embodiment of the present invention is illustrated in FIG. 4a. The band 236 includes an arm 238 on a first end 252 which is inserted into a notch 240 on a second end 254, the arm 238 engaging a protrusion, shown below, to secure the band 236 to the stabilizer bar 20. A first type of attachment is illustrated in FIG. 4b, taken along line 4b-4b of FIG. 4a. After the band 236a is positioned around the stabilizer bar 20, a hooked portion 244a of the arm 238a is retained in the notch 240A by engagement with a recessed portion 246a in the protrusion 242a, securing the band 236 to the stabilizer bar 20.

Alternatively, as illustrated in FIG. 4c, the arm 238b includes a V-shaped recess 244b. After the band 236b is positioned around the stabilizer bar 20, the V-shaped recess 244b of the arm 238b is retained in the notch 240b by engagement with a corresponding V-shaped projection 246b on the protrusion 242b. However, it is to be understood that the V-shaped recess 244b can be on the protrusion 242b and the corresponding V-shaped projection 246b can be on the arm 238b.

Preferably, returning to FIG. 4a, the band 236 further includes a pair of apertures 248. After engagement of the arm 238 with the protrusion 242, a peg 246 is inserted in each of the apertures 244. The peg 246 engages the outer surface 38 of the stabilizer bar 20 to further secure the band 236 to the stabilizer bar 20.

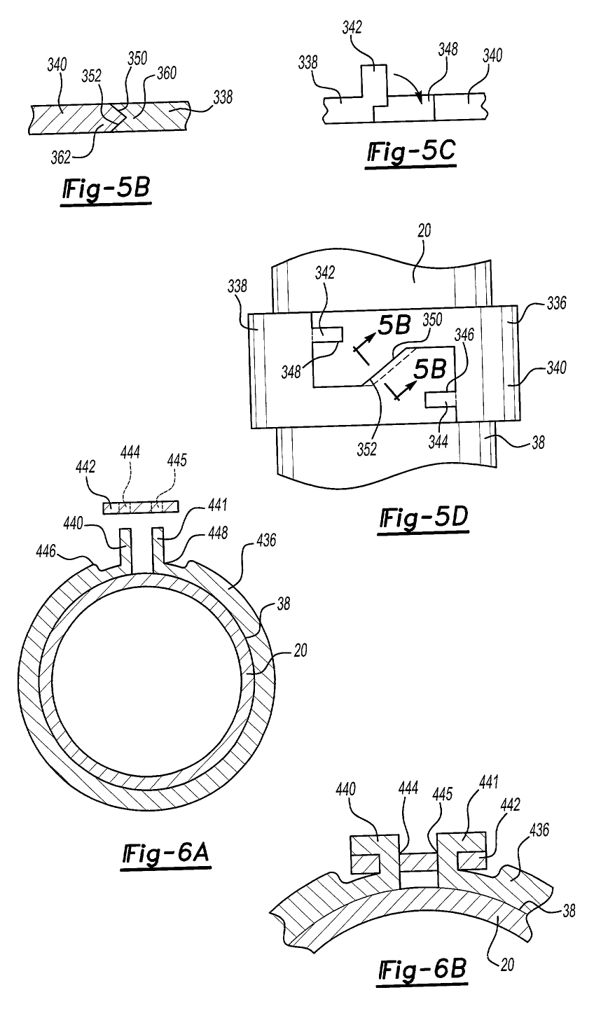

FIG. 5a illustrates a third embodiment of the band 336. The band 336 includes a first portion 338 and a second portion 340, each portion 338 and 340 including a deflectable tab 342 and 344, respectively, a notch 346 and 348, respectively, and an inclined edge 350 and 352, respectively. As shown in FIG. 5b, taken along line Y-Y of FIG. 5d, the first inclined edge 350 includes a recess 360 and the second inclined edge 352 includes a corresponding projection 362. As the inclined edges 350 and 352 are slid together, the projection 362 engages the recess 360, guiding the movement of and securing the inclined edges 350 and 352. Alternatively, the first inclined edge 350 can include the recess 360 and the second inclined edge 352 can include the projection 362.

The tabs 342 and 344 are then deflected to engage the corresponding notch 348 and 346, respectively, as shown in FIG. 5c. The engagement of the tabs 342 and 344 in the notches 348 and 346, respectively, prevent reverse movement of the inclined edges 350 and 352 and removal of the band 336. After deflection of the tabs 342 and 344, the band 338 is secured around the stabilizer bar 20 as illustrated in FIG. 5d.

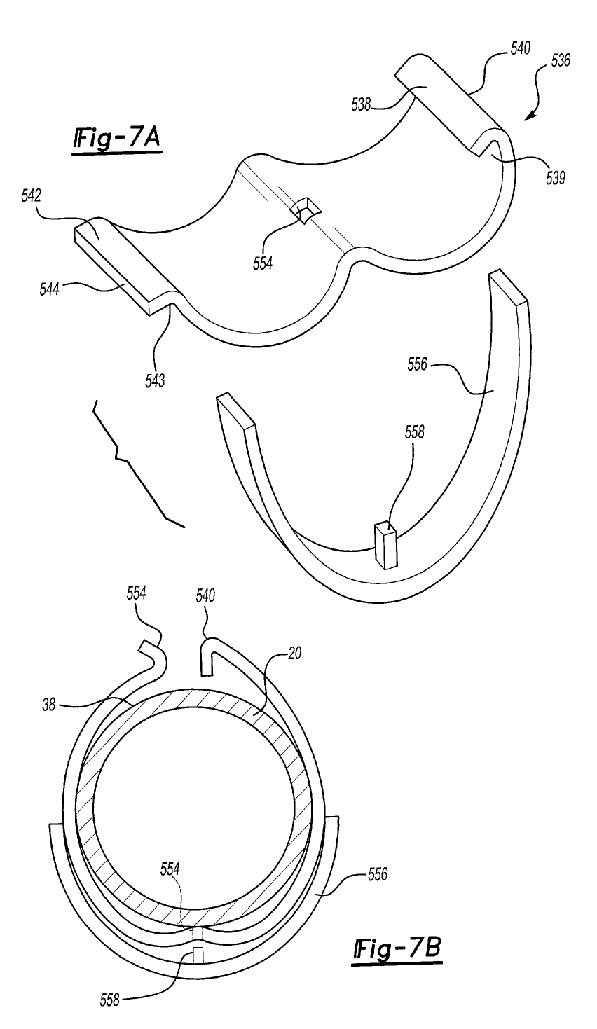

A fourth embodiment is illustrated in FIG. 6a. The band 436 includes a pair of flanges 440 and 441 each located on a first end 446 and an opposing second end 448, respectively, of the band 436. Preferably, the flanges 440 and 441 are substantially parallel to each other and substantially perpendicular to the stabilizer bar 20. A bracket 442 includes a pair of apertures 444 and 445 which each align with the flanges 440 and 441. The bracket 442 is positioned on the clamp 436 such that each of the flanges 440 and 441 pass through one of the apertures 444 and 445, respectively. After positioning the bracket 442 on the clamp 436, the flanges 440 and 441 are deflected 90° outwardly, as shown in FIG. 6b, to tightly secure the band 436 to the outer surface 38 of the stabilizer bar 20.

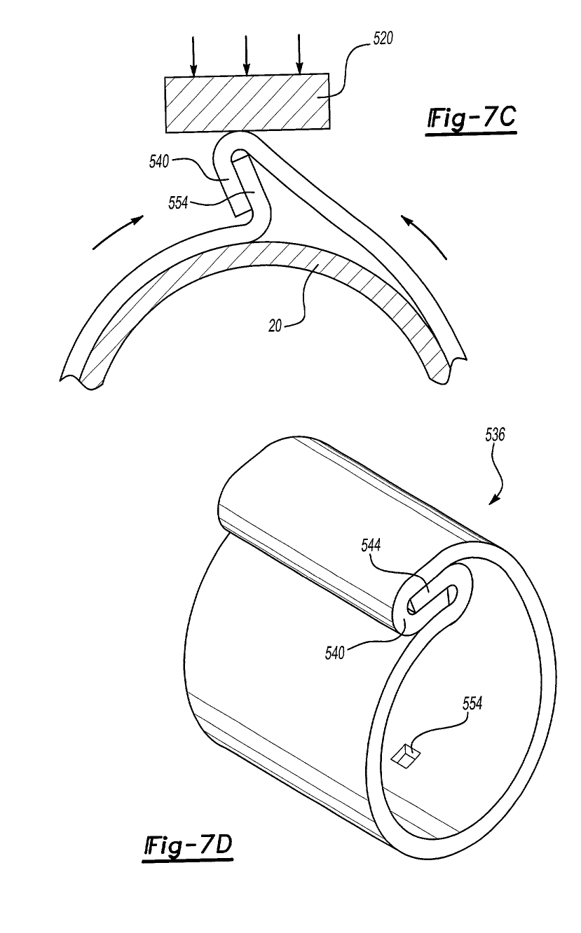

FIG. 7a illustrates a fifth embodiment of the band 536. The band 536 includes a first curved portion 538 with a first recess 539 on a first end 540 and a second curved portion 542 with a second recess 543 on an opposing second end 544. The band 536 is positioned over a C-shaped trough 556. As the stabilizer bar 20 is pressed downwardly into the trough 556, as shown in FIG. 7b, the band 536 wraps around the outer surface 38 of the stabilizer bar 20, the ends 540 and 544 moving inwardly. As shown in FIG. 7c, as the stabilizer bar 20 is positioning in the trough 556, the first curved portion 538 enters the second recess 543 and the second curved portion 542 to enter the first recess 539. The engaging first and second curved portions 538 and 542 are slightly crushed by crusher 520, slightly stretching the material of the band 536. As illustrated in FIG. 7d, the ends 540 and 544 are secured together to tightly secure the band 536 around the outer surface 38 of the stabilizer bar 20. The stabilizer bar 20 is removed from the trough 556 with the band 536 attached.

Preferably, the band 536 further includes a hole 554 positioned substantially in the center of the band 536 which aligns with a pin 558 in the trough 556 during attachment of the band 136 to the stabilizer bar 20. As the stabilizer bar 20 is pressed downwardly in the trough 556, the pin 558 engages the hole 554 to prevent sliding of the band 536 and to ensure the band 536 is positioned in the proper location on the stabilizer bar 20.

Accordingly, the present invention provides bands 36a and 36b fixedly attached to a stabilizer bar 20 which contacts bushings 32a and 32b, respectively, as the stabilizer bar 20 begins to move laterally during vehicle turning to prevent further lateral movement of the stabilizer bar 20.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A vehicle suspension system comprising:
a stabilizer bar connected to a vehicle wheel; and
at least one band secured about said stabilizer bar which interacts with at least one bushing positioned about said stabilizer bar and adjacent to said at least one band to prevent lateral movement of said stabilizer bar.

2. The vehicle suspension system as recited in claim 1 wherein said band includes an attachment portion on a first end and a notched portion on an opposing second end, said attachment portion expanding after entry through said notched portion to secure said band to said stabilizer bar.

3. The vehicle suspension system as recited in claim 2 wherein said attachment portion is substantially U-shaped and includes a pair of opposing projections, expansion of said projections after entry through said notched portion retaining said projections by a pair of opposing protrusions of said notched portion.

4. The vehicle suspension system as recited in claim 2 wherein said band further includes an alignment mechanism to prevent sliding of said band during attachment to said stabilizer bar.

5. The vehicle suspension system as recited in claim 1 wherein an arm on a first end of said band engages a protrusion on a second end of said band to secure said band to said stabilizer bar.

6. The vehicle suspension system as recited in claim 5 wherein said arm includes a hooked portion which engages a recess on said protrusion to secure said band to said stabilizer bar.

7. The vehicle suspension system as recited in claim 5 wherein said arm includes one of a recess and a corresponding projection and said protrusion includes the other of said recess and said projection, said projection engaging said recess to secure said band to said stabilizer bar.

8. The vehicle suspension system as recited in claim 5 wherein said band further includes a pair of apertures each receiving a peg to further secure said band to said stabilizer bar.

9. The vehicle suspension system as recited in claim 1 wherein a first inclined edge of a first portion of said band is slidingly engaged with a second inclined edge of a second portion of said band to secure said band to said stabilizer bar.

10. The vehicle suspension system as recited in claim 9 wherein each of said portions further include a protrusion and a notch, said protrusion of each of said portions being deflected to each engage said notch of said other of said portions to secure said band to said stabilizer bar.

11. The vehicle suspension system as recited in claim 9 wherein said first inclined edge includes one of a projection and a recess and said second inclined edge includes the other of said projection and said recess, said projection and said recess engaging during sliding of said edges to guide movement of said edges.

12. The vehicle suspension system as recited in claim 1 wherein a first end and an opposing second end of said band each include a flange, a bracket including a pair of apertures which correspond to said flanges is positioned on said band such that each of said flanges is received in one of said apertures, deflection of said flanges securing said band to said stabilizer bar.

13. The vehicle suspension system as recited in claim 1 wherein said band includes an first curved portion having a first recess on a first end and a second curved portion having a second recess on an opposing second end, said curved portions engaging opposing recesses to secure said band to said stabilizer bar.

14. The vehicle suspension system as recited in claim 13 wherein said band further includes an alignment mechanism to prevent sliding of said band during attachment to said stabilizer bar.

15. A vehicle suspension system comprising:
a stabilizer bar connected to a vehicle wheel;
a vehicle frame;
a pair of bushings positioned about said stabilizer bar, said stabilizer bar secured to said frame by a mounting bracket positioned over each of said pair of bushings; and
a pair of bands secured about said stabilizer bar and each adjacent to one of said pair of bushings which interact with said pair of bushings to prevent lateral movement of said stabilizer bar.

16. The vehicle suspension system as recited in claim 15 wherein each of said pair of bands are adjacent to an inner side of one of said pair of bushings.

17. The vehicle suspension system as recited in claim 15 wherein each of said pair of bands are adjacent to an outer side of one of said pair of bushings.

18. The vehicle suspension system as recited in claim 17 wherein said band includes a substantially U-shaped attachment portion including a pair of opposing projections on a first end and a notched portion including a pair of opposing protrusions on an opposing second end, expansion of said projections after entry through said notched portion retaining said projections by said protrusions to secure said band to said stabilizer bar.

19. The vehicle suspension system as recited in claim 15 wherein an arm on a first end of said band engages a protrusion on a second end of said band to secure said band to said stabilizer bar.

20. The vehicle suspension system as recited in claim 19 wherein said arm includes a hooked portion which engages a recess on said protrusion to secure said band to said stabilizer bar.

21. The vehicle suspension system as recited in claim 19 wherein said arm includes one of a recess and a corresponding projection and said protrusion includes the other of said recess and said projection, said projection engaging said recess to secure said band to said stabilizer bar.

22. The vehicle suspension system as recited in claim 15 wherein a first inclined edge of a first portion of said band includes one of a projection and a recess and is slidingly engaged with a second inclined edge of a second portion of said band including the other of said projection and said recess such that said projection and said recess engage during sliding of said edges to guide movement of said edges and to secure said band to said stabilizer bar, each of said portions further including a protrusion and a notch, said protrusions of each of said portions being deflected to each engage said notch of said other of said portions to secure said band to said stabilizer bar.

23. The vehicle suspension system as recited in claim 15 wherein a first end and an opposing second end of said band each include a flange, a bracket including a pair of apertures which correspond to said flanges is positioned on said band such that each of said flanges is received in one of said apertures, deflection of said flanges securing said band to said stabilizer bar.

24. The vehicle suspension system as recited in claim 15 wherein said band includes an first curved portion having a first recess on a first end and a second curved portion having a second recess on an opposing second end, said curved portions engaging opposing recesses to secure said band to said stabilizer bar.

25. A method for preventing lateral movement of a stabilizer bar of a vehicle suspension system comprising the steps of:
mounting said stabilizer bar to a vehicle with at least one bushing;
securing at least one band about said stabilizer bar adjacent to said at least one bushing;
axially twisting said stabilizer bar; and
interacting said at least one band with said at least one bushing to prevent lateral movement of said stabilizer bar.
